(19) United States
(12) Patent Application Publication
(10) Pub. No.: US 2022/0389617 A1
(43) Pub. Date: Dec. 8, 2022

(54) NOZZLE DEVICE AND MANUFACTURING METHOD FOR A NOZZLE DEVICE

(71) Applicant: DEUTSCHE INSTITUTE FÜR TEXTIL-UND FASERFORSCHUNG DENKENDORF, Denkendorf (DE)

(72) Inventors: Martin HOSS, Reichenbach (DE); Lothar RUFEIS, Reichenbach (DE)

(21) Appl. No.: 17/776,876

(22) PCT Filed: Nov. 2, 2020
(86) PCT No.: PCT/EP2020/080690

§ 371 Date: May 13, 2022

(30) Foreign Application Priority Data
Nov. 13, 2019 (DE) 102019130565.9

(51) Int. Cl. D01D 4/02; D04H 1/56; B29C 48/05; B29C 48/345; B29C 48/355; B29C 48/14; B29C 48/30; B29C 48/25; B29C 48/32; B23P 15/16

(52) U.S. Cl. CPC D01D 4/025; D04H 1/56; B29C 48/05; B29C 48/345; B29C 48/355; B29C 48/146; B29C 48/3001; B29C 48/25686; B29C 48/32; B23P 15/16

(57) ABSTRACT

A nozzle device for producing a random-laid fiber product including a melt nozzle having an arrangement of a plurality of melt channels. The nozzle device including a gas channel having an opening which is associated with a plurality of melt channels of the arrangement, wherein the gas channel is designed to produce a gas emission which the melt emitted from the melt channels collects. The melt nozzle including an arrangement of capillary tubes in order to form the melt channels. A method for producing a nozzle device including providing of a nozzle body having one or more receiving channels and the arranging and fastening of capillary tubes in the one or more receiving channels.

### CROSS REFERENCE TO RELATED APPLICATIONS

This application is a National Stage of PCT Application No. PCT/EP2020/080690 filed on Nov. 2, 2020, which claims priority to German Patent Application No. 10 2019 130 565.9 filed on Nov. 13, 2019, the contents each of which are incorporated herein by reference thereto.

### TECHNICAL FIELD

The invention refers to a nozzle device for manufacturing of a random-laid fiber product.

### BACKGROUND

A melt-blow nozzle device is known from WO 92/07121 that comprises a melt nozzle having an output tip that comprises two surfaces joining in a strip-shaped surface section that confine an angle. The strip-shaped surface section comprises a multiplicity of openings forming mouths of melt channels extending through the output tip. The melt channels can be applied with a polymer in a flowable condition in order to eject the polymer from the openings. Plates are attached to the melt nozzle that form slit-shaped air output channels assigned to the melt channels in order to output air to each side of the row of openings substantially the form of converging air leaves or air blades. This art of melt-blow nozzles (also denoted Exxon-principle) is relatively simple to manufacture. However, only melt channels can be bored having a length-to-diameter-ratio (L/D) of at most 20, usually <15, such that the formation of finest fibers is limited.

A nozzle device is known from U.S. Pat. No. 6,833,104 B2 by means of which very fine polymer fibers can be produced. A nozzle is manufactured by connecting thin plates in which the melt channels are introduced by means of etching. The manufacturing technique allows very long melt channels and the nozzle withstands high pressures. However, the manufacturing method is very expensive. In addition, such nozzles cannot be used in existing standard spinning heads due to their construction.

US 2005/0056956 A1 discloses a nozzle device having a nozzle plate, which limits a hollow space for application with gas. Melt nozzles extend through the hollow space that can be fed with polymer melt. The melt nozzles extend through a gas distribution plate, an opening of a spacer as well as through receive openings of a terminal plate. The receive openings form gas ejection openings, wherein one gas ejection opening is assigned to one melt nozzle in each case. The melt nozzle is arranged in the gas ejection opening such that gas can be ejected around the melt nozzle between the melt nozzle and the edge of the gas ejection opening such that the gas surrounds the end of the melt nozzle and the polymer melt ejected from the melt nozzle in a coating-like manner. The construction size of the individual melt nozzles with the respectively assigned gas ejection openings requires an arrangement of the melt nozzles over a relatively large area in order to achieve a sufficient nozzle number. This, however, makes the homogeneous melt distribution and gas distribution more difficult compared with melt-blow nozzle devices having melt nozzles arranged along a line.

Besides the melt throughput rate, the number of melt channels is the decisive factor with regard to the productivity and thus very important for the economic efficiency of a melt-blow system. Industrially used nozzles comprise capillary bores in a number of 30-50 holes per inch (HPI). The nozzles have to be made of a high alloy tool steel that withstands massive alternating thermal stresses over a long period. The melt throughput rate depends on the pressure with which the melt is applied in order to press it out of the nozzle. Limits are set depending on the material and depending on the construction in this case.

### BRIEF SUMMARY

The object of the present invention is to provide an improved concept for a melt-blow nozzle device.

A nozzle device for manufacturing of a random-laid fiber product having a melt nozzle with an arrangement of multiple melt channels, wherein the nozzle device comprises a gas channel having a mouth that is assigned to multiple melt channels of the arrangement of multiple melt channels, wherein the gas channel is configured to create a gas ejection that captures melt ejected from the melt channels, wherein the melt nozzle comprises an arrangement of capillary tubes for formation of the melt channels.

A method for manufacturing of a nozzle device having a gas channel having a mouth that is assigned to multiple melt channels of an arrangement of multiple melt channels, wherein the gas channel is configured to create a gas ejection that captures melt ejected from the multiple melt channels, comprising: providing a nozzle body having one or multiple location channels and arranging and attaching capillary tubes inside the one or the multiple location channels, wherein the capillary tubes form the multiple melt channels.

The nozzle device according to the invention for producing a random-laid fiber product fiber product or melt-blow nozzle device comprises a melt nozzle having an arrangement of multiple melt channels and a gas channel having a mouth that is assigned to multiple melt channels of the arrangement. The nozzle device can comprise multiple gas channels, the mouths of which are respectively assigned to multiple melt channels of the arrangement. The gas channel is configured to create a gas ejection that captures the melt ejected from the mouths of the melt channels. The melt nozzle according to the invention comprises an arrangement of capillary bores for formation of the melt channels. Particularly the mouths of the melt channels can be realized from a capillary tube in each case. The gas channel or gas channels are preferably slot-shaped. The mouth or the mouths of the gas channel or gas channels extend preferably along the arrangement of capillary tubes that can be particularly a row or multiple (at least two) rows of capillary tubes. A mouth can be assigned at least to one row of melt channels.

If the melt channels are realized by capillary tubes, as according to the invention, melt channels can be created that comprise a high length-to-diameter ratio. In doing so, with the diameter of the melt channels being predefined, the nozzle device can be configured with a relatively thick wall thickness adjacent to the melt channels. Particularly, the location channel in the melt nozzle for location of one or multiple capillary tubes can have a long length, which makes the melt nozzle very stable. This in turn allows to apply the melt channels with a relatively high melt pressure, which in turn results in a high throughput rate. In total the economic efficiency and productivity can be increased compared with known nozzle devices in which an arrangement of multiple melt channels is assigned to one gas channel. In addition, the invention allows to manufacture extremely fine fibers. Up to date the fineness was limited, in that the bores forming the melt ejection channels could not have respectively fine diameters due to their construction. Because due to the maximum realizable length-to-diameter ratios created by means of bores, a yet finer bore diameter would have resulted in a respective yet shorter length of the m melt channels up to present and thus to a lesser wall thickness around the melt ejection openings. This in turn would have potentially required a reduction of the pressure with which the melt channels are applied. With the invention technical limits existing up to date can be overcome. By means of the long melt ejection channels that are possible according to the invention, very fine fibers can be produced with high reproducibility and with high productivity.

Additional advantageous optional features and embodiments are derived from the following description.

The nozzle device is preferably configured for pressure application for output of the melt of 60 bar or more, preferably even 100 bar or more. Particularly the wall thickness of the melt nozzle at the melt channels is preferably so thick, such that it can be applied with a respective pressure.

The capillary tubes can be arranged in one or multiple location channels. The one or the more location channels are preferably closed around the capillary tube or the capillary tubes comprised in the location channel. For example, the one or the multiple location channels can be closed around the capillary tube or the capillary tubes that are comprised by the location channel, in that the location channel is filled with solder around the capillary tube or the capillary tubes.

For example, it is possible that an individual location channel is provided for each capillary tube.

In the sense of a particularly high stability of the melt nozzle, the location channel or location channels can have a length in each case that is at least half the length as the length of each of the capillary tubes of the manufactured nozzle device.

For the purpose of a high density of melt channels it is considered to be advantageous, if multiple capillary tubes are arranged in one location channel. The location channel can be slot-shaped. The capillary tubes are arranged in the location channel with short distance from each other, preferably however arranged in a manner capillary tube wall to capillary tube wall.

The capillary tubes can be arranged in the location channel in one or multiple (at least two) rows. With multiple rows a high line density of melt channels can be achieved, wherein for determination of the line density, for example, the combined number of melt channels along and on a virtual straight line can be determined, wherein the line is orientated orthogonal to the flow-through direction of a melt channel. The capillary tubes of one row can be offset relative to the capillary tubes of an adjacent row and a section of each capillary tube of one row can be arranged between successive capillary tubes in the adjacent row, such that the capillary tubes are tightly arranged next to each other for the purpose of a high density of mouths.

For example, the inner diameter of capillary tubes can be smaller than or equal to 500 micrometers, smaller than or equal to 400 micrometers, smaller than or equal to 300 micrometers or smaller than or equal to 200 micrometers, particularly smaller than or equal to 100 micrometers, for example 50 micrometers.

The use of capillary tubes allows that the melt channels comprise a length-to-diameter ratio of more than or equal to 20 in embodiments. The melt channels can particularly comprise a length-to-diameter ratio of more than or equal to 35, more than or equal to 50 or more than or equal to 60.

Basically the nozzle device can be configured according to the Exxon-principle. Particularly, the melt nozzle can be a melt nozzle for the nozzle device according to the Exxon-principle, wherein however instead of bores, capillary tubes are inserted.

The nozzle device can be configured to such that the one or more gas ejection openings result in a leaf-shaped or a blade-shaped gas ejection and indeed under an angle of more than 0° relative to the ejection direction of the melt. Gas ejection openings can create particularly converging gas ejections that are leaf- or blade-shaped, for example.

The gas blow, particularly air blow, through the at least one gas channel is preferably carried out under an angle relative to the flow direction of the melt channel through its mouth that is different from 0°. For example, the angle can have an amount of inclusively 25° to inclusively 35°, particularly approximately 30°. If the melt that passes through the arrangement of capillary tubes is applied by means of two air channels with air from two sides, the angle in which the air blow is carried out relative to the flow direction of the melt channel is preferably equal from both sides, e.g. 30° in each case.

The walls of the melt nozzle can converge, for example, or can comprise converging wall surfaces that join each other in the output section or at the output side of the nozzle body at the tip thereof. The wall surfaces can confine, for example, an angle of two times approximately 30°, i.e. approximately 60°.

The method according to the invention for manufacturing a nozzle device, as described herein, comprises at least providing a nozzle body having one or multiple location channels and arranging of capillary tubes in the one or the multiple location channels. The location channels are preferably closed around the capillary tubes. For attaching the capillary tubes in the location channels it is particularly considered: press fitting, welding, gluing, soldering. The manner of attachment of soldering is preferably advantageous, because it allows the creation of long connections and thus extensive connections between the capillary tubes and the walls of the location channel or the location channels.

For attaching the capillary tubes in the one or the multiple location channels, a method of diffusion soldering that is known per se has been turned out to be particularly advantageous. This results in an intermetallic phase, having a melting temperature of the connection that is higher than the melting temperature of the solder. This allows cleaning by heating also with very high temperatures or the temperature only has to be controlled less accurately during the cleaning process.

Prior to soldering the capillary tubes are preferably closed at least on one side, preferably on both sides. The capillary tubes can be closed by welding, particularly laser welding, for example. This results in that solder cannot flow into the capillary tubes during soldering attachment. Preferably the capillary tubes are filled in order to avoid introduction of contaminations in the capillary tubes during reopening of the capillary tubes closed at least on one side or on both sides.

Further features and embodiments are derived from the dependent claims, the following description as well as the figures. They show by way of example:

### BRIEF DESCRIPTION OF THE DRAWINGS

FIG. 1—a melt-blow device in a schematic, partly cut illustration,

FIG. 2—an enlarged view of a section of the illustration of the nozzle device according to FIG. 1 in the area of the mouths of the melt and gas channels,

FIG. 3—a yet further enlarged view of a section of the illustration of the nozzle device according to FIG. 2,

FIG. 4—a melt nozzle in a top view onto the output side,

FIG. 5—a view mainly corresponding to FIG. 3 of a nozzle device according to the invention having capillary tubes in the melt nozzle that form melt channels,

FIG. 6—a top view onto an output side of a melt nozzle having multiple capillary tubes in a location channel in each case,

FIG. 7—a top view onto an output side of a melt nozzle having multiple capillary tubes in a slot-shaped location channel,

FIG. 8—a top view onto an output side of melt nozzle having multiple rows of capillary tubes in a slot-shaped location channel,

FIG. 9a—an embodiment having melt channels in the flanks of a melt nozzle in a sectional illustration,

FIG. 9b—a highly schematic top view onto a section of the melt nozzle according to FIG. 9a,

FIG. 10—a flow scheme of a method according to the invention,

FIG. 11—a sectional illustration in part through a capillary tube having a closed end and a filler in the interior,

FIG. 12—a sectional view through a melt nozzle with a capillary tube arranged therein that is closed on both ends and contains filler therein, and

FIG. 13—a sectional illustration through the melt nozzle according to FIG. 12 after removing the closure of the ends of the capillary tube.

### DETAILED DESCRIPTION

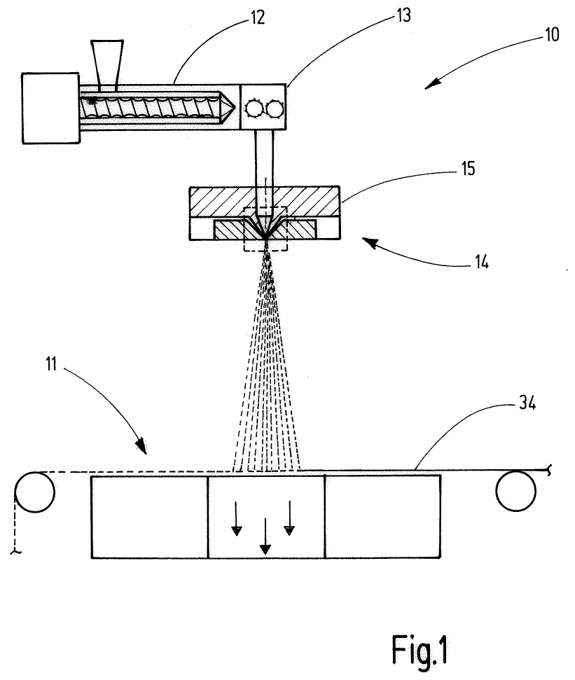

FIG. 1 shows an example of a melt-blow device 10. The melt-blow device 10 comprises a tray 11, an extruder 12 for melting of a plastic, usually a plastic granulate, and a spinning pump 13 connected thereto for supply of the melt to a nozzle device 14. For example, the nozzle device 14 can comprise a melt distributor, melt filter and different temperature and pressure sensors without illustrating them in detail. The nozzle device 14 further comprises a melt nozzle 15 and a device 16 with at least one, preferably at least two channels 17, 18 for applying the ejected melt with air. The melt nozzle 15 can be a section of one or multiple channels of the device 16 for application with air. In other embodiments the channels 17, 18 for application with air are arranged in one or multiple bodies that are bodies separate from the melt nozzle 15, which however can be attached to the melt nozzle 15.

The nozzle device 14 illustrated in FIG. 1 is part of a type of nozzle devices 14 that are based on an invention of the company Exxon. This type of nozzle devices 14 is, therefore, frequently characterized as operating according to the Exxon-principle.

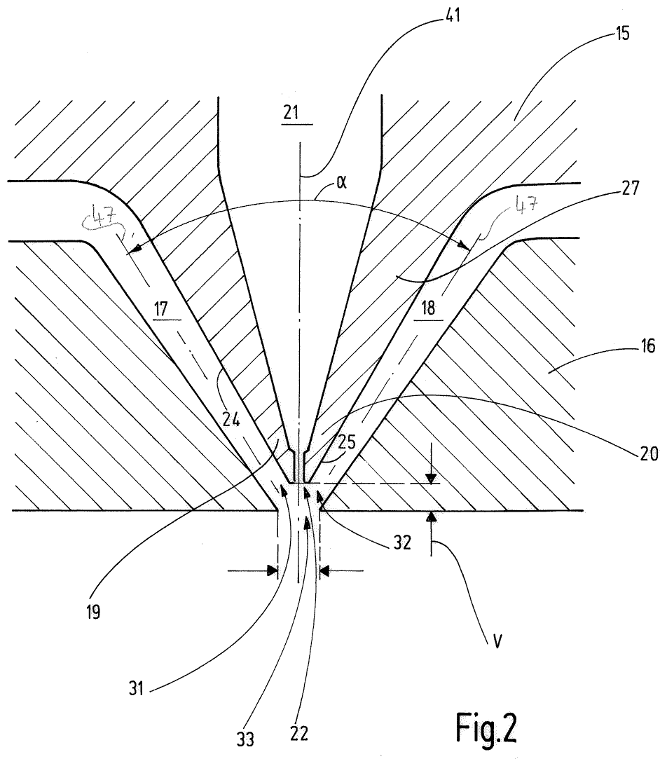

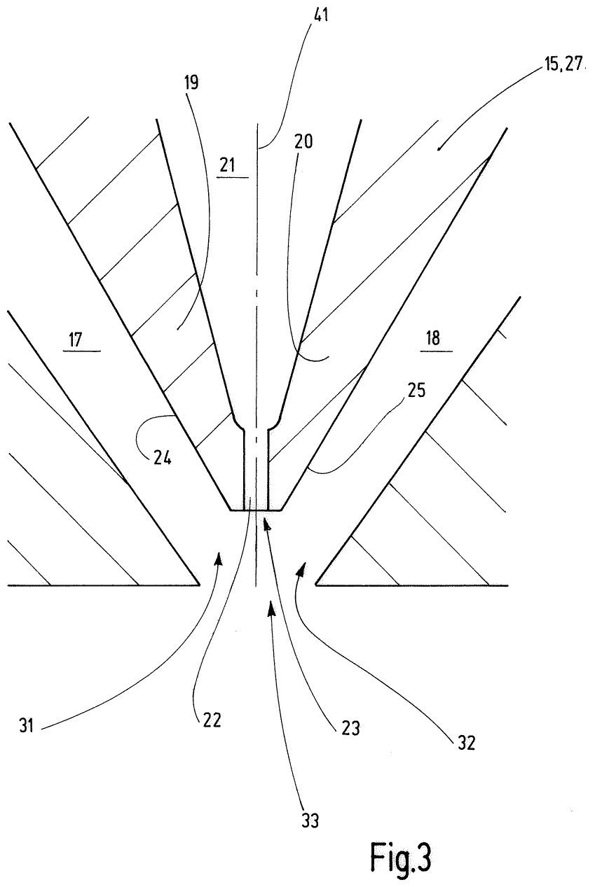

FIG. 2 shows a section (compare box with dashed lines in FIG. 1) of the view according to FIG. 1. FIG. 3 shows a section of the view according to FIG. 2. As shown in FIG. 2, the melt nozzle 15 is approximately prism-shaped in cross-section. The melt nozzle 15 comprises two walls 19, 20. Usually a melt distribution channel 21 extends between walls 19, 20 from which melt channels 22 extend having a mouth at an output side of the melt nozzle 22. The walls 19, 20 comprise outer surfaces 24, 25 that join each other in the approximately strip-shaped output side 26 of melt nozzle 15. The walls 19, 20 form an output tip 27 of melt nozzle 15 due to the tapering orientation of walls 19, 20.

In known melt nozzles 15 melt channels 22 can be formed by capillary bores. The capillary bores, melt channels 22 or openings or mouths 23 in the output side 26 are in general arranged one after another in a single row. Usually the melt channels 22 have an inner diameter in the range of 0.2 to 0.4 mm and comprise a length diameter ratio L/d of 5-15. The capillary bores comprise a constant diameter or cross-section.

The melt-blow device 10 comprises a device 16 for application of the melt exiting from the mouths 23 of melt channels 22 with an air stream. This device 16 comprises two devices denoted as air blades. They are formed by means of at least two air channels 17, 18, which can be applied with air. The air channels 17, 18 are arranged on both sides of arrangement 30 of mouths 23 of melt channels 22, e.g. one or more rows. The air channels 17, 18 are assigned to the arrangement 30 of mouths respectively, through which the melt exits from the melt nozzle 15. Each air channel 17, 18 comprises a longitudinal mouth 31, 32 that extends along the arrangement 30.

The melt nozzle 15 can be offset backwardly relative to the mouths 31, 32 of air blades (offset V). The narrowest cross-section of the construction for the exiting primary air is thus formed by exit gap 33 at the end of the output tip 27. In the exit gap 33 the primary air comprises the maximum flow velocity. According to the Exxon-principle, the blow of the melt exiting from the melt channels is carried out under an angle of approximately 60° (2×30°). Particularly possible is an angle α in the range from 50° (2×25°) inclusively to 70° (2×35°) inclusively. The angle α (e.g. 60°) is confined by virtual center lines 47 that extend virtually in the cross-sectional plane of melt nozzle 15 in the center between the wall surfaces 24, 25 of wall 19, 20 of melt nozzle 15 and the opposite further surface that limits the air channel 17, 18 together with the wall surface 24, 25. The center lines 47 are preferably symmetrical to center line 41.

In the melt-blow method the plastic granulate is melted in the extruder 12 and is continuously supplied to the nozzle device 14 via spinning pump 13. The polymer melt extruded from the melt nozzle 15 is captured directly after exiting from a converging tempered air stream from air channels 17, 18—the so-called primary air—which mixes directly after the nozzle exit with the environment air—the so-called secondary air. The fibers formed from the melt are cooled on their way to the tray 11 and are captured as entangled fibers in the form of a non-woven fabric 34. The deposition is mostly carried out on an air-permeable structure 11, as for example on a deposition band 11 or a sieve drum 11 that is in addition provided with an underpressure. It serves to retain the fibers on the tray 11 and to discharge excessive primary air.

The capillary bore density and the melt throughput rate are decisive factors for the economically efficient operation of a melt-blow device 10.

Capillary bores with diameters in the range of d=0.2-0.4 mm can in general only be manufactured up to a length of maximum the twentyfold, i.e. 20 d, of the diameter. Regularly melt nozzles are manufactured having a length-to-diameter ratio of 8 to at most 15. A ratio of length-to-diameter higher than 20 cannot be manufactured in such fine diameters by means of drilling. A smaller melt channel diameter results in a required slim construction of walls 19, 20 or legs of melt nozzle 15, because the melt channel cannot be manufactured in an arbitrary length. This is correlated with a thin configuration of walls 19, 20 at their most delicate site. In doing so, an Exxon-nozzle with drilled melt channels 22 can at most be applied with a pressure of 30-50 bar. The polymer throughput (g/h/min=grams/hole/minute) creates a respective inner pressure. For finest fibers produced with smallest capillaries the productivity (g/h/min) is thus capped.

As solution a location channel 35 is manufactured having a cross-section dimension larger than a capillary bore according to the prior art and this location channel 35 or at least a section of this location channel 35 is filled with one capillary tube 36 or multiple (at least two) capillary tubes 36. One capillary tube 36 with its tube channel forms a melt channel 22 respectively. Capillary tubes 36 can be manufactured in nearly arbitrary length over a wide diameter and wall thickness range. Thereby capillary tubes 36 can comprise very small capillary tube inner diameters. For example, capillary tubes 36 can have an inner diameter of 0.1 millimeters to inclusively 0.5 millimeters or a diameter of less than or equal to 0.1 millimeters. For example, the length to inner diameter ratio can be higher than or equal to 15 or more in embodiments, e.g. higher than or equal to 20 or more.

By means of using capillary tubes 36 melt channels 22 including mouths 23 can be created, for example, having an inner diameter of less than or equal to 500 micrometers, less than or equal to 400 micrometers, less than or equal to 300 micrometers, less than or equal to 200 micrometers, less than or equal to 100 micrometers or less than or equal to 75 micrometers, for example 50 micrometers. For example, the length-to-diameter ratio of melt channels can be higher than or equal to 15 or more, e.g. higher than or equal to 20 or more. Particularly, the length-to-diameter ratio can be higher than or equal to 35, higher than or equal to 50 or higher than or equal to 60. Such melt channels 22 could not have been produced by means of drilling.

Substantial advantages of the invention are the possibility of manufacturing of ultra-fine fibers and/or fibers with high productivity due to possible higher pressures and thus higher throughputs. According to the invention, the length of the melt channel or the capillary tube can be 5-10 times longer than usual. The thickness of wall 19, 20 at the most delicate site can be, for example, up to the twofold or threefold thicker than in known melt nozzles 15. In doing so, the supportable inner pressure and the polymer throughput can increase about up to the two- to threefold, for example. For example, the nozzle device 14 can be configured so stable, such that the melt pressure in the melt distribution channel 21 or each melt channel 22 can comprise at least 60 bar, particularly preferably at least 100 bar. This results in a respective higher productivity about, for example, up to the two- to threefold. In addition, an increased length of each of the melt channels 22 up to the mouth 23 allows an improved uniformity of the fibers amongst each other.

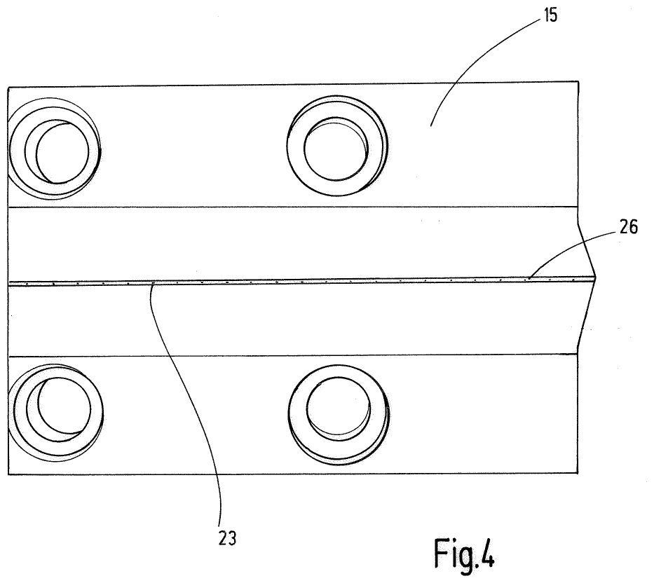

For illustration purposes FIG. 4 shows an exemplary view onto a strip-shaped output side 26 of melt nozzle 15 of the embodiment according to FIGS. 1-3 into which the melt channels 22 open out.

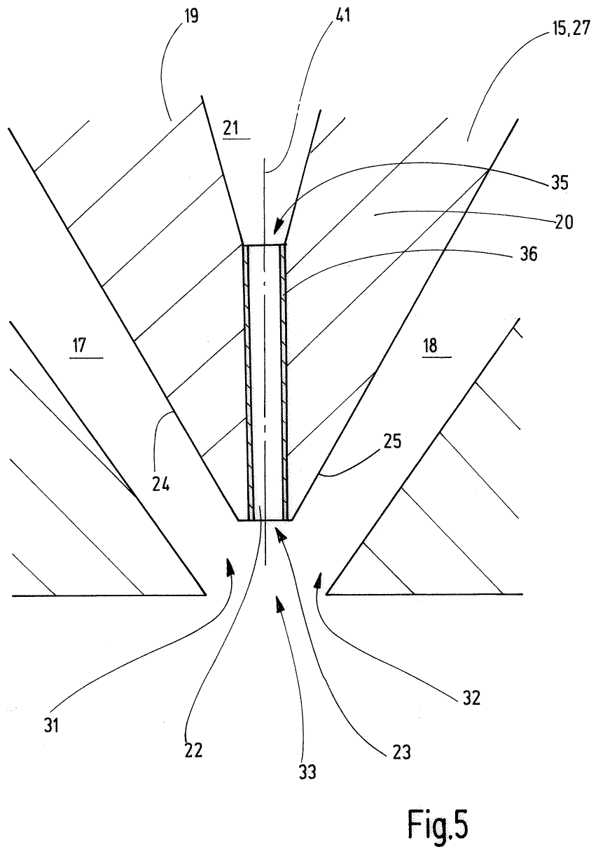

FIG. 5 shows an illustration corresponding to FIG. 3 of a cross-section through a melt-blow device 10 having a melt nozzle 15 according to the invention. The description referring to FIGS. 1 to 3 above, as well as the illustration thereof can be referred to for the embodiment according to the invention according to FIG. 4. As apparent in the illustration, however, different to the melt nozzle 15 according to FIGS. 1 to 3, a capillary tube 36 is arranged in the melt nozzle 15 that forms a melt channel 22 instead of a capillary bore and preferably also the mouth 23 thereof for output of melt. This capillary tube 36 comprises a higher length to inner diameter ratio than the capillary bore illustrated in FIG. 3.

Apart therefrom in preferred embodiments according to the invention, no air channel 17, 18 is present that would surround a specific capillary tube 36, but no other, or that would surround a specific group of capillary tubes 36, but no additional.

In the embodiment according to FIG. 4, the walls 19, 20 have a higher thickness at sites of the melt nozzle 15 decisive for the stability, particularly pressure stability, as apparent from the figure, than the respective walls 19, 20 of melt nozzle 15 according to FIG. 3.

The capillary tube 36 can have a round, particularly circular, outer contour and a round, particularly circular, inner contour in cross-section. It would be basically possible to use capillary tubes 36 with a polygonal contour at least in sections in the cross-section on the inner and/or outer side, however, this is not preferred, because of the manufacturing effort and the costs for such capillary tubes.

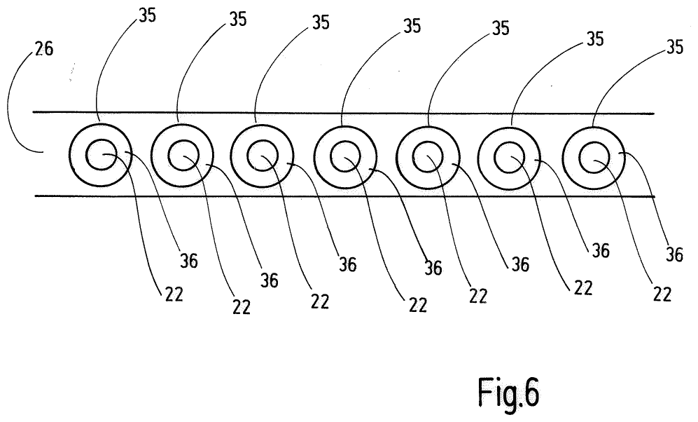

FIGS. 6 to 8 schematically show a top view on strip-shaped output sides 26 of embodiments of the invention.

In an embodiment capillary tubes 36 are introduced with distance to one another in discretely arranged location bores that form location channels 35. An example for this is illustrated in FIG. 6. The location channel 35 is closed between the capillary tube 36 and the inner wall surface 37 of the location channel 35. For example, the location channel 35 can be filled with solder between the capillary tube 36 and/or the area between the location channel 35 and the capillary tube 36 can have a thickness of zero due to a press-fit, such that the location channel 35 is closed between the capillary tube 36 and the inner wall surface 37 of location channel 35.

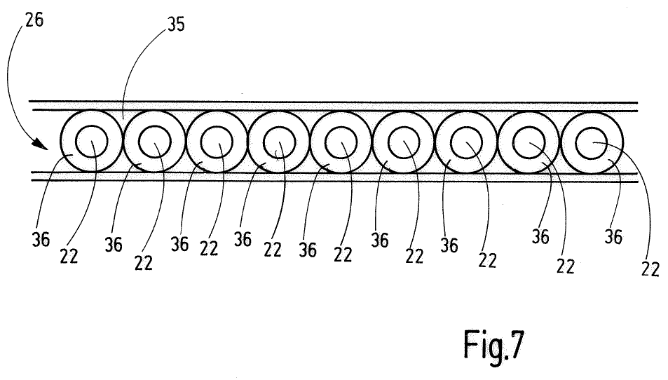

Embodiments are possible in which capillary tubes 36 are arranged in a row after one another in a slot-shaped location channel 35 as an alternative or in addition. An example is illustrated in FIG. 7.

The thickness of the wall 19, 20 of capillary tubes 36 can be the limiting factor of the line density of the holes in embodiments for the indication of which the unit holes per inch (hpi) is usual.

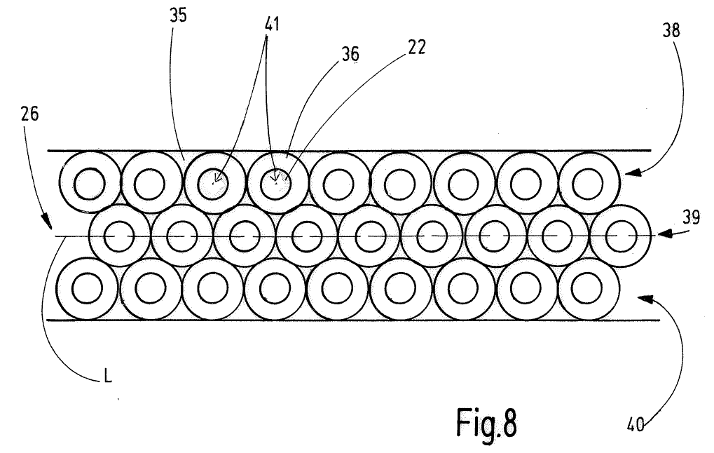

A particularly high line density can be achieved by using particularly thin-walled capillary tubes 36. Alternatively or additionally, capillary tubes 36 can be arranged in a slot-shaped location channel 35 in at least two or more rows 38, 39, 40 of capillary tubes 36, as illustrated in FIG. 8. In FIG. 8 not every capillary tube is denoted with reference sign 36 and not every melt channel is denoted with reference sign 22 for sake of clarity. The capillary tubes 36 of one row 38, 39 or 40 can be offset in longitudinal direction of row 38, 39 or 40 relative to the capillary tubes 36 of the adjacent row 38, 39 or 40, for example by half the distance between two center lines 41 of two adjacent capillary tubes 36, which center lines 41 virtually extend centrally through the capillary tubes 36 respectively. Center lines 41 are respectively illustrated for selected capillary tubes 36 by means of a dot. In the embodiment according to FIG. 8, three rows 38, 39, 40 of capillary tubes 36 are arranged adjacent to one another, for example. The capillary tubes 36 of one row 38, 39 or 40 are offset to the capillary tubes 36 of each adjacent row 38, 39 or 40. Alternatively in embodiments only two rows can be arranged adjacent to one another, for example. As an example two rows side by side with capillary tubes 36 of one row that are offset compared to the capillary tubes 36 of the other row in the row direction.

Also by means of such embodiments a relatively high line density of melt channels 22 or mouths 23 can be achieved. Here the line density can be determined in that the number of capillary mouths 23 or capillary tube center lines 41 along a straight line L or lineament of straight lines is determined, which line L or lineament extends through the center points of mouths 23, through a center point of mouth 23 and orthogonal to a center line or orthogonally intersecting center lines 41. The straight lines of lineament extend from center point to center point and/or center line 41 to center line 41 orthogonal to the center line 41.

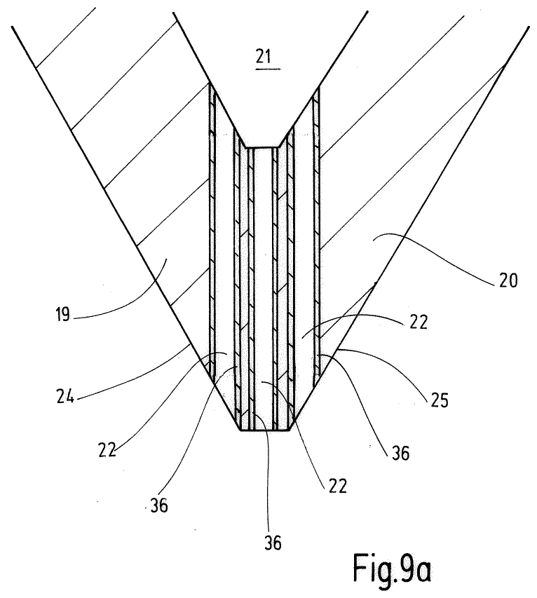

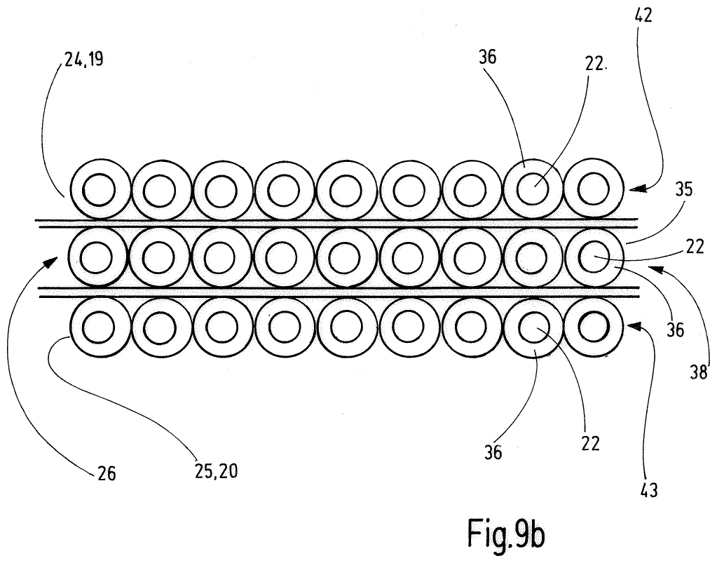

Alternatively or additionally, one or more rows 42, 43 of capillary tubes 36 can be arranged in one or both walls 19, 20 of melt nozzle 15 adjacent to the line-shaped output side 26 that is arranged at the end of output tip 27 of melt nozzle 15. An embodiment having rows 42, 43 of capillary tubes 36 in the flanks of the output tip 27, which rows 42, 43 extend parallel to the one or the multiple rows 38, 39, 40 in the output side 26 is illustrated in FIG. 9. FIG. 9a shows an example of a melt nozzle 15 according to the invention in cross-section having capillary tubes 36 arranged in the output section on the output side 26 that form melt channels 22 for output of melt and with melt channels 22 in walls 19, 20 of the nozzle body of melt nozzle 15, wherein the melt channels in the walls 19, 20 are arranged adjacent to the one or the multiple rows of channels 38, 39, 40 in the output side 26 and open out in the outer surfaces 24, 25. As illustrated in FIG. 9a, the ends of the capillary tubes 36 that form the melt channels 22 in walls 19, 20 of the nozzle body in the melt nozzle 15 preferably end flush with outer surfaces 24, 25. Otherwise, the end faces of capillary tubes 36 can be arranged orthogonal to the longitudinal extension of the capillary tubes 36 in the walls 19, 20. Preferably the capillary tubes 36 do not project beyond the wall surfaces 24, 25 in order to not impede the air stream.

FIG. 9b schematically shows a top view onto the output side 26 of melt nozzle 15 according to FIG. 9a. The melt channels 22 in the walls 19, 20 can also be formed by arrangement of one or more capillary tubes 36 in one or more location channels 35. For sake of clarity not every capillary tube is marked with a reference sign 36 and not every melt channel is marked with a reference sign 22. By means of the described solution a high density of melt channels 22 measured along a line L can be achieved. The line density can also be determined as explained in the context with FIG. 8.

Howsoever a high line density is provided in embodiments—e.g. as explained above—it preferably amounts at least 30 holes per inch up to at least 50 holes per inch or more.

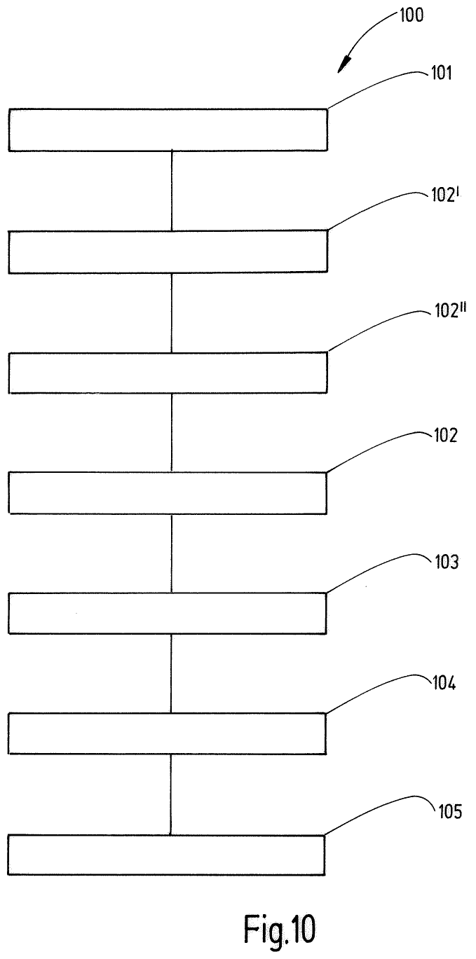

In the context of an exemplary method 100 (see FIG. 10) for manufacturing of a nozzle device 14 according to the invention or a melt nozzle 15 according to the invention, a nozzle body for a melt nozzle 15 is provided (instruction 101 in FIG. 10), which nozzle body comprises one or multiple location channels 35. The location channels 35 can be manufactured by a conventional technique. For example, the location channels 35 can be drilled and/or eroded. Based on the relatively large diameter or the relatively wide width, long location channels 35 can be produced.

Capillary tubes 36 are arranged in the one or more location channels 35 in the nozzle body (instruction 102) and attached there (instruction 102). The attachment 102 can be carried out by press-fitting, gluing, welding, preferably however by soldering. By means of soldering 102, a long connection and thus an extensive connection can be created between the capillary tube 36 and the nozzle body. The solder attachment of capillary tubes 36 is carried out preferably in a vacuum, preferably by means of diffusion soldering. A diffusion soldering method is, for example, indicated under the term “diffusion hard soldering (in the oven)” in table 2 of standard DIN EN 4632-001, table 2. Thereby an alloy is created between solder and basic material that has a higher melting point than the solder material. In doing so, a very good strength at high temperatures is created. During solder attachment 103, e.g. by means of diffusion hard soldering, however also during gluing, for example, it has to be guaranteed that solder or adhesive does not enter into the capillary tube 36. Also, in other manufacturing methods it can be necessary to avoid that the interior of capillary tubes 36 is blocked or contaminated.

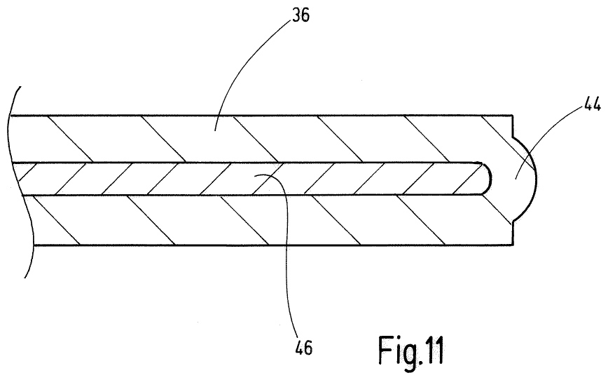

One possibility to avoid this is to close the capillary tube 36 prior to insertion or at least prior to soldering at one end 44 or at both ends 44, 45 of capillary tube 36 (instruction 102″). For example by means of welding, particularly by means of laser welding. FIG. 11 shows a section of a capillary tube 36 having an end 44 closed by means of welding.

The closure of end 44 must be opened again after attachment (instruction 104). This can be carried out by means of erosion, particularly sink erosion, for example. For opening of the closures at the one end 44 or both ends 44, 45 the end 44 or ends 44, 45 can be separated. During opening 104 the capillary tube 36 can be shortened such that the remaining capillary tube 36 has a length having an amount of at most the twofold of the length of the location channel 35 of the manufactured melt nozzle 15. In the course of opening 104 of the closure, the end contour of melt nozzle 15 can be manufactured by erosion.

During removing 104 of closure, ideally care should be taken that contaminations cannot enter into capillary tube 36. By means of the erosion process described above, for example, finest metal removal could enter into the capillary enclosed by capillary tube 36. This metal removal can only be removed again with difficulty. The “exposure” of the capillaries requires high workforce efforts. Avoiding of contamination can be carried out, for example, in that the capillary tube is filled 102′ with a substance that can be removed subsequently. For example, prior to welding 102″ of the one or both ends 44, 45. The substance can be wax or wax-like, for example. The substance can be removed again by heating 105 of melt nozzle 15. FIG. 11 shows by way of example that the interior of capillary tube 36 is filled with a filler 46 that avoids that a contamination enters into the interior of capillary tube 36 during removal of the closure at one end 44 or both ends 44, 45, which shall form the melt channel 22, which contamination cannot or can only be removed with remarkable efforts from the capillary tube 36.

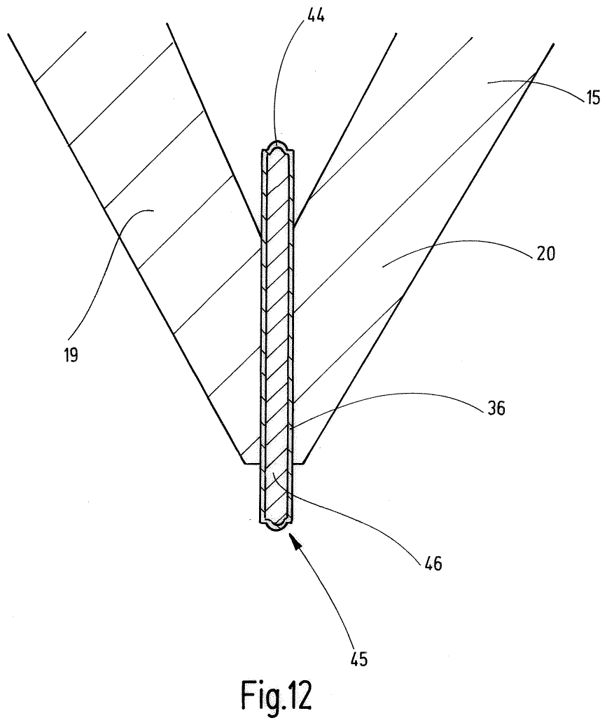

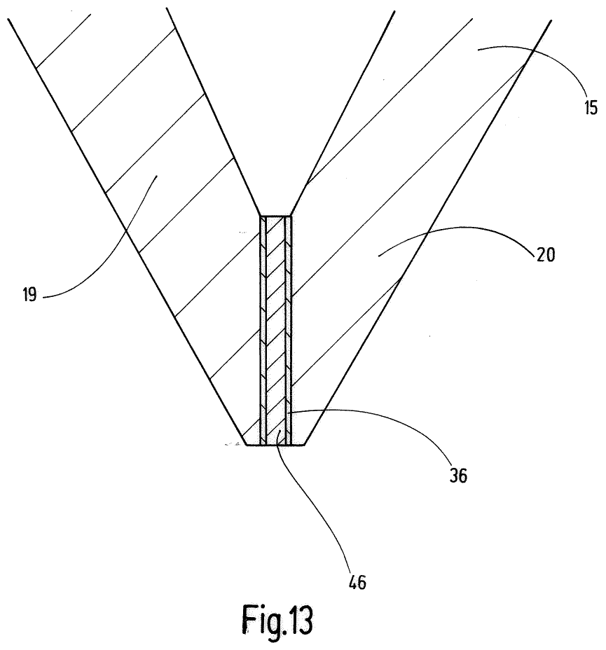

FIG. 12 shows a nozzle body in cross-section in which a filled and closed capillary tube 36 is inserted. FIG. 13 shows the embodiment according to FIG. 14 in which the closures of the two ends 44, 45 are removed, the filler 46 however is still contained in the capillary tube 36.

The manufactured nozzle device 14 can be applied with a melt pressure of, for example, at least 60 bar or even at least 100 bar.

The nozzle device 14 is provided for manufacturing of a non-woven fabric 34 by means of a melt nozzle 15 having an arrangement 38, 39, 40 of multiple melt channels 22. The nozzle device 14 comprises a gas channel 17, 18 having a mouth 31, 32 that is arranged to multiple melt channels 22 of the arrangement 38, 39, 40. The gas channel 17, 18 is configured to create a gas ejection that captures the melt ejected from the melt channels 22, whereby the melt nozzle 15 comprises an arrangement of capillary tubes 36 for forming melt channels 22. The location channel 35 is slot-shaped. The capillary tubes 36 are arranged inside the location channel 35, whereby the capillary tubes are in addition arranged in at least two rows inside location channel 35.

The nozzle device 14 can comprise a gas channel 17, 18 having a mouth 31, 32 that is assigned to multiple melt channels 22 of arrangement 38, 39, 40. The gas channel 17, 18 is configured to create a gas ejection that captures the melt ejected from the melt channels 22. The melt nozzle 15 comprises an arrangement of capillary tubes 36 arranged in a nozzle body for forming melt channels 22. The nozzle body comprises walls 19, 20, whereby the ends of the capillary tubes 36 that form melt channels 22 inside walls 19, 20 of the nozzle body of melt nozzle 15 end flush with one of the outer surfaces 24, 25 respectively. Such capillary tubes open out in only one of the outer surfaces respectively and thereby comprise a planar elliptical mouth. As an alternative, the end faces of capillary tubes 36 are arranged orthogonal to the longitudinal extension of the capillary tubes 36 inside walls 19, 20 and do not project beyond the wall surfaces 24, 25. The mouths of these capillary tubes are planar and circular.

The capillary tubes 36 of one row can be arranged offset to the capillary tubes 36 of an adjacent row.

The capillary tubes 36 can be arranged in one or multiple location channels 35, wherein the one or the multiple location channels 35 are closed around the capillary tube or capillary tubes 36. One location channel 35 can be provided for each capillary tube 36.

The location channel or location channels 35 can have a length that is at least half the length of the capillary tube 36.

The capillary tubes 36 can have an inner diameter of less than or equal to 500 micrometers, less than or equal to 400 micrometers, less than or equal to 300 micrometers, less than or equal to 200 micrometers or less than or equal to 100 micrometers, e.g. 50 micrometers.

The capillary tubes 36 can form melt channels 22 having a length-to-diameter ratio of more than or equal to 20, more than or equal to 35, more than or equal to 50 or more than or equal to 60.

The nozzle device 14 can be configured for a pressure application for output of the melt of 60 bar or more, preferably of 100 bar or more.

A nozzle device 14 according to the invention for manufacturing of a non-woven fabric 34 comprises a melt nozzle 15 having an arrangement 38, 39, 40 of multiple melt channels 22. The nozzle device 14 comprises a gas channel 17, 18 having a mouth 31, 32 that is assigned to multiple melt channels 22 of arrangement 38, 39, 40, wherein the gas channel 17, 18 is configured to create a gas ejection that captures the melt ejected from the melt channels 22. According to the invention, the melt nozzle 15 comprises an arrangement of capillary tubes 36 for formation of melt channels 22. A method 100 according to the invention for manufacturing of a nozzle device comprises providing 101 of a nozzle body 15 having one or multiple location channels 35 and the arrangement 102 and attachment 103 of capillary tubes 36 in the one or the multiple location channels 35.

List of Reference Signs:

| | |
|---|---|
| 10 | melt-blow device |
| 11 | tray |
| 12 | extruder |
| 13 | spinning pump |
| 14 | nozzle device |
| 15 | melt nozzle |
| 16 | device for application with air |
| 17 | air channel |
| 18 | air channel |
| 19 | wall |
| 20 | wall |
| 21 | melt distribution channel |
| 22 | melt channel |
| 23 | mouth |
| 24 | outer surface |
| 25 | outer surface |
| 26 | output side/output section |
| 27 | output tip |
| 30 | arrangement |
| 31 | air channel mouth |
| 32 | air channel mouth |
| 33 | exit gap |
| 34 | non-woven fabric |
| 35 | location channel |
| 36 | capillary tube |
| 37 | inner wall surface |
| 38 | row |
| 39 | row |
| 40 | row |
| 41 | center line |
| 42 | row |
| 43 | row |
| 44 | end |
| 45 | end |
| 46 | filler |
| 47 | center line |
| 100 | method |
| 101 | providing |
| 102′ | filling |
| 102″ | closing |
| 102 | arranging |
| 103 | attaching |
| 104 | opening |
| 105 | removing filler |
| α | angle |
| L | line |
| V | offset |

1. A nozzle device for manufacturing of a random-laid fiber product having a melt nozzle with an arrangement of multiple melt channels, wherein the nozzle device comprises a gas channel having a mouth that is assigned to multiple melt channels of the arrangement of multiple melt channels, wherein the gas channel is configured to create a gas ejection that captures melt ejected from the multiple melt channels, wherein the melt nozzle comprises an arrangement of capillary tubes for formation of the multiple melt channels.

2. The nozzle device according to claim 1, wherein the capillary tubes are arranged in one or multiple location channels, wherein the one or the multiple location channels are closed around the capillary tube or capillary tubes.

3. The nozzle device according to claim 2, wherein one location channel of the one or the multiple location channels is provided for each capillary tube of the capillary tubes.

4. The nozzle device according to claim 2, wherein the one or multiple location channels are slot-shaped and wherein the capillary tubes are arranged inside the one or multiple location channels.

5. The nozzle device according to claim 4, wherein the capillary tubes are arranged inside the one or multiple location channels in one or multiple rows.

6. The nozzle device according to claim 2, wherein the one or the multiple location channels have a length being at least half of a length of the capillary tubes.

7. The nozzle device claim 1, wherein the capillary tubes have an inner diameter of at least one of the following: less than or equal to 500 micrometers, less than or equal to 400 micrometers, less than or equal to 300 micrometers, less than or equal to 200 micrometers, and less than or equal to 100 micrometers.

8. The nozzle device according to claim 1, wherein the arrangement of capillary tubes form melt channels having a length-to-diameter ratio of at least one of the following: higher than or equal to 20, higher than or equal to 35, higher than or equal to 50, and higher than or equal to 60.

9. The nozzle device according to claim 1, wherein the nozzle device is configured for a pressure application for output of melt of 60 bar or more.

10. A melt nozzle for a nozzle device according to claim 1.

11. A method for manufacturing of a nozzle device having a gas channel having a mouth that is assigned to multiple melt channels of an arrangement of multiple melt channels, wherein the gas channel is configured to create a gas ejection that captures melt ejected from the multiple melt channels, comprising: providing a nozzle body having one or multiple location channels and arranging and attaching capillary tubes inside the one or the multiple location channels, wherein the capillary tubes form the multiple melt channels.

12. The method according to claim 11, wherein the capillary tubes are soldered into the one or multiple location channels.

13. The method according to claim 12, wherein the capillary tubes are soldered into the one or the multiple location channels by means of diffusion soldering.

14. The method according to claim 12, wherein the capillary tubes are closed on at least on one side by means of laser welding, prior to the capillary tubes being soldered into the one or multiple location channels.

15. The method according to claim 14, wherein the capillary tubes are filled in order to avoid introducing of contaminations into the capillary tubes during reopening.

16. The nozzle device claim 7, wherein the capillary tubes have an inner diameter of 50 micrometers.

17. The nozzle device according to claim 9, wherein the nozzle device is configured for a pressure application for output of melt of 100 bar or more.

18. The nozzle device according to claim 3, wherein the one or multiple location channels are slot-shaped and wherein the capillary tubes are arranged inside the one or multiple location channels.

19. The nozzle device according to claim 18, wherein the capillary tubes are arranged inside the one or multiple location channels in one or multiple rows.

20. The nozzle device according to claim 19, wherein the one or the multiple location channels have a length being at least half of a length of the capillary tubes.
